(19) United States
(12) Patent Application Publication
(10) Pub. No.: US 2002/0120715 A1
(43) Pub. Date: Aug. 29, 2002

(54) Method of publishing an image

(76) Inventors: Rainer Kuth, Herzogenaurach (DE); Michael Pierer Von Esch, Erlangen (DE)

Correspondence Address: YOUNG & THOMPSON, 745 SOUTH 23RD STREET 2ND FLOOR, ARLINGTON, VA, 22202

(21) Appl. No.: 10/068,904

(22) Filed: Feb. 11, 2002

(30) Foreign Application Priority Data
Feb. 12, 2001 (DE) 10106316.4

(51) Int. Cl. G06F 15/16; G06F 17/60

(52) U.S. Cl. 709/218; 705/2

(57) ABSTRACT

A method of publishing an image (31) produced with an appliance (23) on an Internet page (30), the Internet page (30) being associated with a manufacturer (29), a sales organization or a marketing organization for the appliance (23), and the appliance (23) being in the possession of a customer of the manufacturer (29), the sales organization or the marketing organization.

The invention relates to a method of publishing an image on an Internet page.

If Internet pages belonging to a manufacturer of medical appliances, for example, are used for the presentation of the medical appliances, the Internet pages have to be maintained continually and updated at the shortest possible time intervals, in order to remain attractive to potential purchasers of one of the medical appliances. For this purpose, the manufacturer can, for example, continually publish new images, which have been recorded with one of his medical appliances, on one of the Internet pages. A medical system architecture suitable for recording medical images is disclosed, for example, in DE 198 02 572 A1. The medical system architecture comprises an arrangement for registering medical images, a device for processing the medical images and for recording patient-related data, a device for transmitting the images and data and a device for storing the images and the patient-related data. However, the production and selection of these images or, in general terms, continual updating of the Internet pages is time-consuming and therefore expensive. Techniques for publishing an image on the Internet are disclosed, for example, by U.S. Pat. No. 6,058,428.

Furthermore, EP 1 004 967 A1 discloses a method and a system for creating photo collages. The digitized images needed for the photo collages are provided with an individual code, stored in a database and sorted automatically on the basis of at least one criterion.

One method for the correct, that is to say visually correct, determination of the color information of colored scenes or original images is otherwise described in DE 41 19 489 A1. On the basis of this method, color value signals are derived, pixel by pixel, in accordance with the multi-spectral method. The object of the invention is therefore to provide a precondition for keeping the Internet page attractive to a viewer of the Internet page with the least possible outlay for a proprietor of an Internet page.

The object of the invention is achieved by a method of publishing an image on an Internet page associated with a manufacturer, a sales organization or a marketing organization for an image-providing appliance, having the following method steps:

a) creating the image with the image-providing appliance, the image-providing appliance already being in the possession of a customer of the manufacturer, the sales organization or the marketing organization for the image-providing appliance,

b) automatically assessing the image by using at least one criterion stored on a computer belonging to the image-providing appliance,

c) on the basis of the automatic assessment of the image, transmitting the image data associated with the image to a computer belonging to the manufacturer, the sales organization or the marketing organization for the image-providing appliance, and

d) publishing the image on the Internet page.

According to the invention, the image-providing appliance, which may be a digital camera or video apparatus, for example, is already in the possession of the customer, that is to say the image-providing appliance has been sold to the customer, for example by the manufacturer of the image-providing appliance, and delivered to the customer. The customer or a person authorized by the customer uses this appliance to create an image which, following creation, is assessed automatically with at least one criterion stored on the computer belonging to the appliance. The criterion or the criteria can, for example, be stored on the computer before the appliance is delivered or can be copied onto the computer from a CD-ROM. The advantage in using the CD-ROM is that the criterion or the criteria can also be changed over the course of time. According to a preferred variant of the invention, the criterion used for the assessment of the image is the signal-to-noise ratio of the image. Thus, the image is published only when it has a high image quality. The image is subsequently published on the Internet page if, for example, a person creating the image desires it. Consequently, new images of high quality are continuously published on the Internet page. The Internet page therefore continually remains attractive to the viewer of the Internet page, without the manufacturer, the sales organization or the marketing organization for the appliance having to expend any special effort.

The method according to the invention is particularly interesting if, according to one embodiment of the invention, the appliance with which the image is created is a medical appliance. In this case, for example the customer or a person authorized by the customer creates an image of a patient with the medical appliance in the course of a medical examination or a medical study. According to a preferred variant of the invention, the criterion used as a basis for the assessment of the image can be an illness and/or an injury of a person examined with the medical appliance. Thus, the image is published only when it can be associated with the picture of an illness or injury of the examined person which is of interest to a viewer of the Internet page, for example. The image is subsequently published on the Internet page if this is desired, for example, by a doctor treating the patient.

In order that the manufacturer, the sales organization or the marketing organization for the appliance have an influence on the quality of the published image, according to a variant of the invention, they define the criterion or the criteria for the assessment of the image.

According to a further variant of the invention, provision is made for the manufacturer, the sales organization or the marketing organization to be capable of updating the criterion or the criteria via the Internet. The criterion or the criteria can then be updated, for example, when the computer belonging to the appliance makes contact with the Internet page of the manufacturer, the sales organization or the marketing organization because of publication of an image.

The Internet page can be designed to be particularly interesting to the viewer if, in accordance with a further embodiment of the invention, the manufacturer, the sales organization or the marketing organization defines a ranking of published images and publishes it on a further Internet page. The viewer therefore has an additional stimulus to view the Internet page or Internet pages of the manufacturer, the marketing organization or the sales organization repeatedly, in particular if one of his images is published. In addition, the result is also a stimulus to publish an image on the Internet page in the first place.

The Internet page can be made still more attractive for the viewer if, on the basis of variants of the invention, persons who view the image can assess the image individually and/or the ranking of the images is carried out by means of an individual assessment by the persons.

Particularly good structuring of the Internet pages results, according to an embodiment of the invention, if various rankings for images of various diseases, injuries or patient groups are set up.

According to a further variant of the invention, the medical appliance is a computer tomograph, a lithotripter, a magnetic resonance appliance or an X-ray appliance.

An exemplary embodiment of the invention is illustrated in the appended schematic drawings, in which:

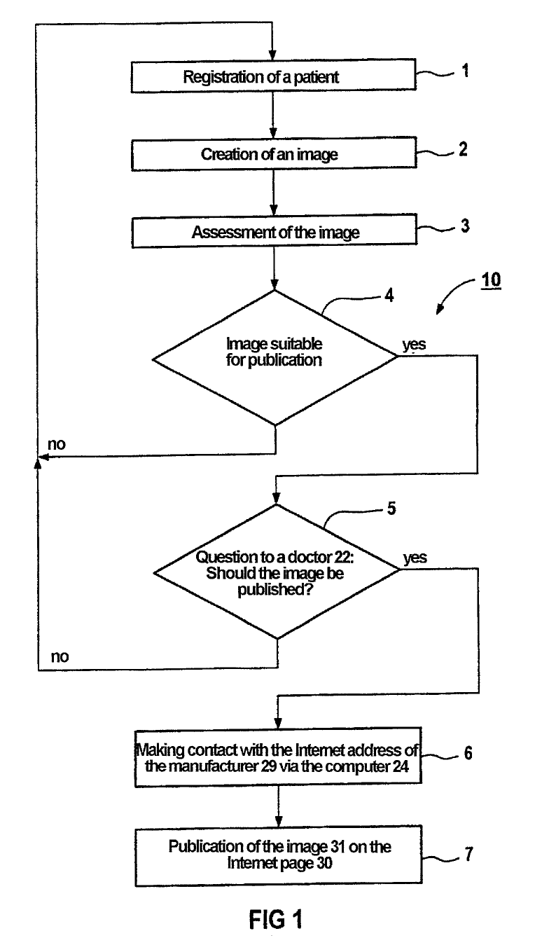

FIG. 1 shows a flow diagram illustrating the method according to the invention,

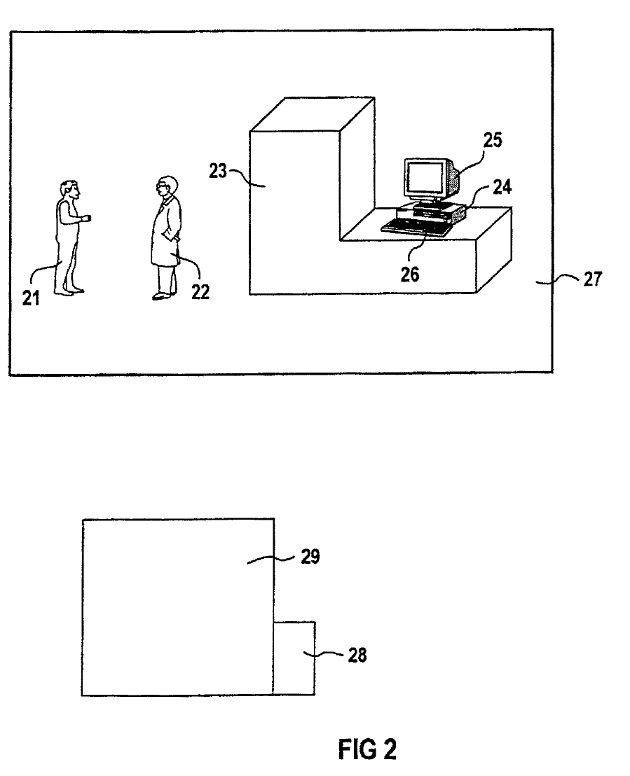

FIG. 2 shows a medical appliance,

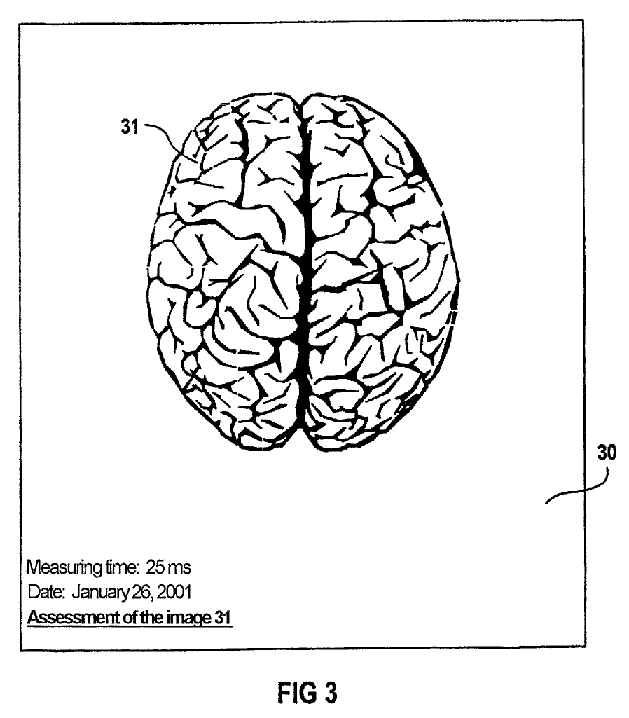

FIG. 3 shows an Internet page,

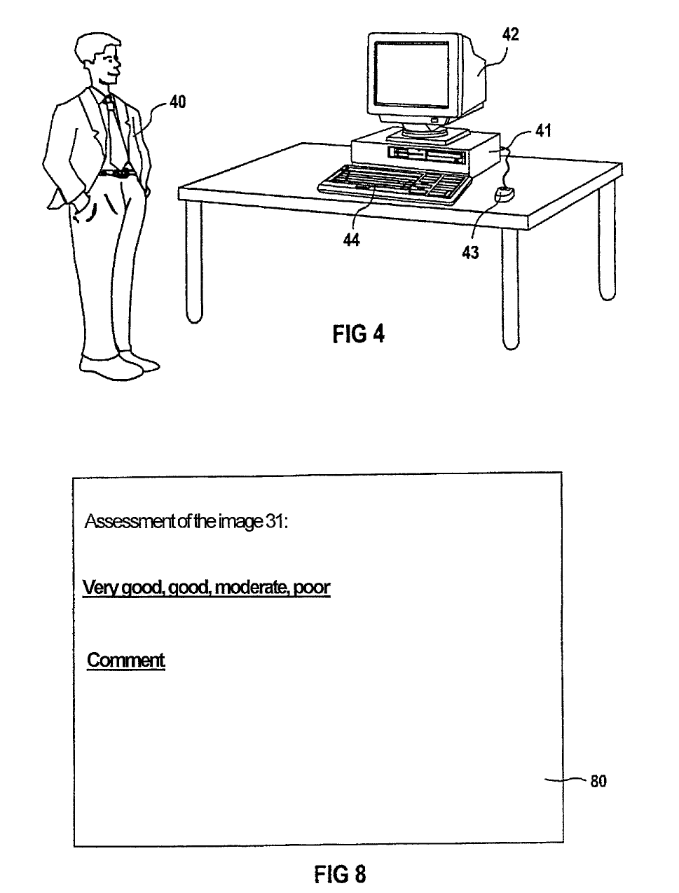

FIG. 4 shows a person who views Internet pages, and

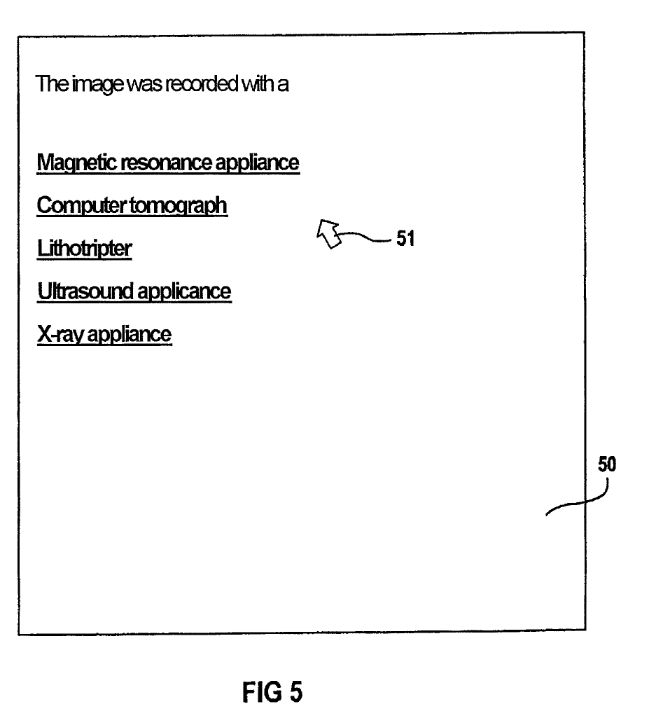

FIGS. 5 to 8 show further Internet pages.

FIG. 1 shows a flow diagram 10 with steps 1 to 7 in order to illustrate the method according to the invention, which will be explained in more detail using FIG. 2.

A patient 21 shown schematically in FIG. 2 is to be examined by a doctor 22, using a magnetic resonance appliance 23. In the case of the present exemplary embodiment, the magnetic resonance appliance 23 belongs to a university A and is located in a university clinic 27 belonging to the university A.

Before the examination begins, the doctor 22 greets the patient 21 and registers the patient 21 by inputting his personal details into a computer 24 belonging to the magnetic resonance appliance 23 or calling up the personal details in the computer 24, if the personal details have already been stored in the computer 24 (step 1 of the flow diagram 10). In addition, the computer 24 is connected to the Internet.

In addition to the personal details, the doctor 22 also inputs statements about the type of examination into the computer 24, in particular whether an examination of the lungs, heart or head of the patient 21 is to be carried out with the magnetic resonance appliance 23. In the case of the present exemplary embodiment, an examination of the head of the patient 21 is carried out, since the patient 21 has sustained a head injury.

Then, an image 31 of the patient 21 is created with the magnetic resonance appliance 23 (step 2 of the flow diagram 10). The image 31 is illustrated schematically in FIG. 3 and is an image 31 of the brain of the patient 21. During the creation of the image 31, a suitable computer program runs on the computer 24 in the case of the present exemplary embodiment and registers the time duration for the creation of the image 31. Following the creation of the image 31, a further computer program in the computer 24 is automatically activated, which determines the signal-to-noise ratio of the image data associated with the image 31.

A further computer program then runs automatically on the computer 24, and assesses the image 31 in accordance with criteria stored on the computer 24 (step 3 of the flow diagram 10). In the case of the present exemplary embodiment, these criteria comprise the image quality of the image 31, based on the signal-to-noise ratio, and the type of injury or disease of the patient 21, which determines the type of examination. The criteria for assessing the image 31 in the case of the present exemplary embodiment are defined by the manufacturer 29 of the magnetic resonance appliance 23 and were stored on the computer 24 before the magnetic resonance appliance 23 was supplied to the university A.

The purpose of assessing the image 31 is to find out automatically whether the image 31 is of interest for publication on an Internet page 30 associated with the manufacturer 29 (step 4 of the flow diagram 10), said page being stored on an Internet server 28 connected to the Internet and associated with the manufacturer 29. In the case of the present exemplary embodiment, the image 31 is of interest for publication if it has a high signal-to-noise ratio and was created on the basis of an examination of the lungs, heart or head.

Since the image 31 is of high quality and originates from a head examination, the computer 24 automatically proposes to the doctor 22, by means of the monitor 25 belonging to the computer 24, publication of the image 31 on the Internet page 30 of the manufacturer 29 of the magnetic resonance appliance 23 (step 5 of the flow diagram 10).

In the case of the present exemplary embodiment, the doctor 22 is interested in publication and communicates this fact to the computer 24 by means of the keyboard 26 of the computer 24. The computer 24 then automatically makes contact with an Internet address belonging to the manufacturer 29 of the magnetic resonance appliance 23 (step 6 of the flow diagram 10), so that the image 31 is published on the Internet page 30 (step 7 of the flow diagram 10), by the image data associated with the image 31 being transmitted to the Internet server 28 in a generally known way. In addition to the image 31, in the case of the present exemplary embodiment the time duration for the creation of the image 31 and the date of creation are published on the Internet page 30. In the case of the present exemplary embodiment, the image 31 was created on Jan. 26, 2001.

Should the manufacturer 29 have changed the criteria for assessing an image created with the magnetic resonance appliance 23, then in the case of the present exemplary embodiment the changed criteria are transmitted automatically to the computer 24 as soon as it has made contact with the Internet address of the manufacturer 29. Images which are created with the magnetic resonance appliance 23 following the updating of the criteria are assessed on the basis of the changed criteria.

Should the doctor 22 not wish to publish the image 31, the computer 24 does not make contact with the Internet address of the manufacturer 29, and publication of the image 31 on the Internet page 30 does not take place.

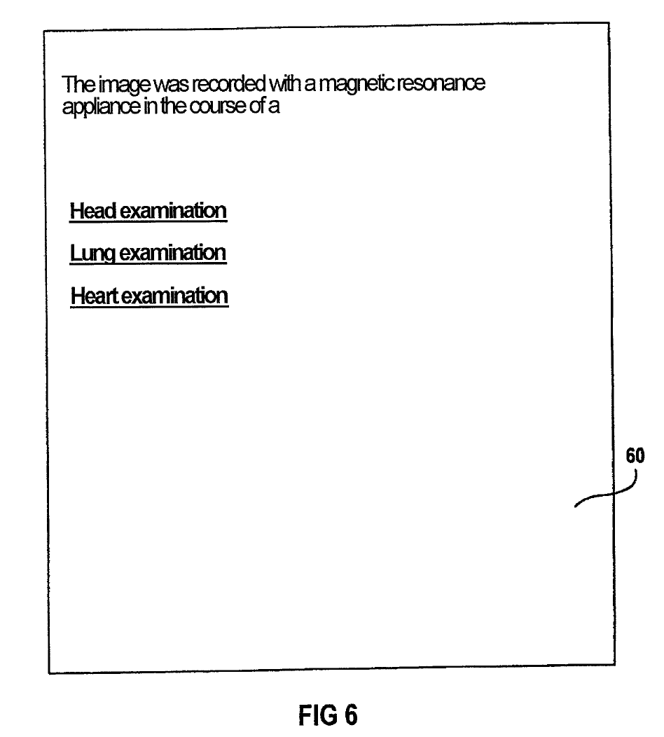

If a person 40, who is shown schematically in FIG. 4 and can also be the doctor 22 or the patient 21, wishes to view the image 31 on the Internet, then in the case of the present exemplary embodiment, he can make contact with the Internet address of the manufacturer 29 by using a computer 41 connected to the Internet. After making contact with the Internet address, an Internet page 50 shown schematically in FIG. 5 is built up on a monitor 42 belonging to the computer 41. The person 40 can then select whether he wishes to view an image which has been recorded with a magnetic resonance appliance, a computer tomograph, a lithotripter, an ultrasound appliance or an X-ray appliance from the manufacturer 29. In the case of the present exemplary embodiment, the person 40 wishes to view the image 31, that is to say an image recorded with a magnetic resonance appliance. Therefore, the person 40 moves a marker 51 inserted into the image 40 to the word “magnetic resonance appliance” by using a computer mouse 43 connected to the computer 41 and, in a manner generally known, clicks on the word “magnetic resonance appliance” with the computer mouse 43. An Internet page 60 shown schematically in FIG. 6 is then built up on the monitor 42.

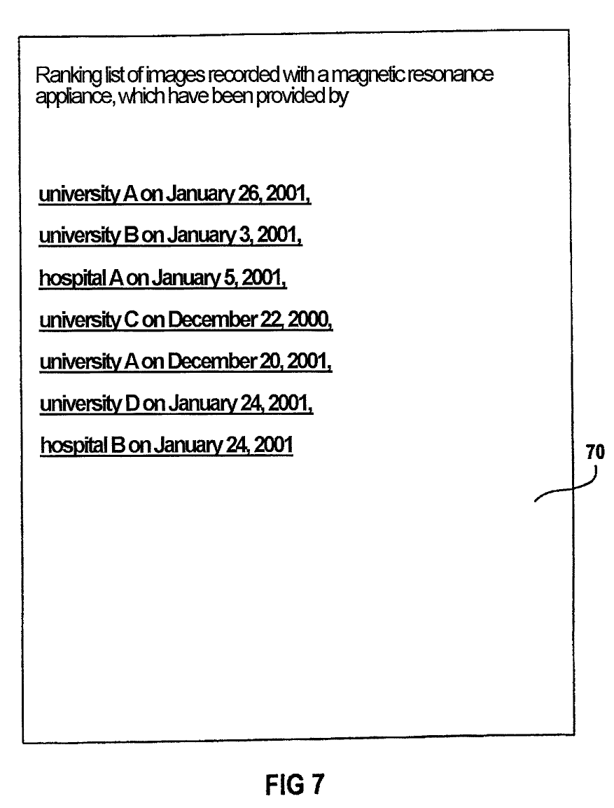

The person 40 can then select whether he wishes to view an image recorded with a magnetic resonance appliance which originates from a head, lung or heart examination. In the case of the present exemplary embodiment, the person 40 wishes to view the image 31, that is to say an image from a head examination, and clicks on the word “head examination” with the computer mouse 43. An Internet page 70 shown schematically in FIG. 7 is then built up on the monitor 42.

By means of the Internet page 70, the person 40 is in each case able to view an image which, in the case of the present exemplary embodiment, was made available by university A on Jan. 26, 2001, by university B on Jan. 3, 2001, by hospital A on Jan. 5, 2001, by university C on Dec. 22, 2000, by university A on Dec. 20, 2000, by university D on Jan. 24, 2001 and by hospital B on Jan. 24, 2001. In the case of the present exemplary embodiment, university A in each case made an image available on Jan. 26, 2001, which is the image 31, and a further image on Dec. 20, 2000. In addition, the Internet page 70 corresponds to a ranking of the images made available by the universities A, B, C, D and the hospitals A and B. In the case of the present exemplary embodiment, the image 31, which was made available by university A on Jan. 26, 2001, occupies the first place, and the image from hospital B, which was published on Jan. 24, 2001, occupies the last place.

Since the person 40 wishes to view the image 31, he clicks on the phrase “university A on Jan. 26, 2001”, as a result of which the Internet page 30 is built up on the monitor 42 and the person 40 can view the image 31. Furthermore, the person 40 can assess the image 31 individually himself, in order in this way to influence the ranking of the images published by the universities A to D and the hospitals A and B. In order to assess the image 31 individually, the person 40 clicks on the phrase “assessment of the image 31” on the Internet page 30, as a result of which an Internet page 80 illustrated schematically in FIG. 8 is built up on the monitor 42.

By means of the Internet page 80, the person 40 can then assess the image 31 individually, by deciding whether the image 31 is “very good”, “good”, “moderate” or “poor”, by clicking on the appropriate word, shown on the Internet page 80, with the computer mouse 43. If the person 40 wishes to comment on the image 31, he can click on the word “comment” on the Internet page 80, as a result of which a suitable window, not illustrated but generally known, opens on the monitor 42, in order that the person 40 can write a comment by using the keyboard 44 of the computer 41. The comment is subsequently published on the Internet page 30 with the image 31.

If the person 40 has assessed the image 31 individually, the ranking of the images published by the universities A to D and the hospitals A and B is determined and, if necessary, the Internet page 70 illustrated in FIG. 7 is modified.

Furthermore, in the case of the present exemplary embodiment, there are corresponding rankings for images recorded with a magnetic resonance appliance from a lung or a heart examination. There are also similar rankings for images which have been recorded with a computer tomograph, a lithotripter, an ultrasound appliance or an X-ray appliance.

For the method according to the invention, individual assessment or commenting on the images by a person 40 is otherwise optional. A ranking can also be defined by the owner of the Internet address, that is to say by the manufacturer 29, by a marketing organization or by a sales organization or can even be omitted entirely.

The selection of the medical appliances, in particular of the magnetic resonance appliance 23, is to be understood to be only an example. It is also possible for other medical or non-medical appliances, such as a digital camera or video apparatus, to be used.

The Internet pages 30, 50, 60, 70 and 80 illustrated in FIGS. 3 and 5 to 8 are likewise only of an exemplary nature. An owner of a medical appliance does not necessarily have to be a university either, as is described by way of example in the embodiment.

The criteria for assessing the image 31 and the type of recording are also to be understood only as examples. In particular, recordings of other body parts are also possible. Nor must the patient 21 necessarily be a human. The method is also possible for images of an animal or, if it is used for non-medical purposes, even for objects.

The criteria for assessing the image 31 do not necessarily have to be capable of being updated or loaded via the Internet. Nor do they need to be stored on the computer 24 before the medical appliance is delivered to the customer. They can also be stored on the computer 24 subsequently, for example with a CDROM.

1. A method of publishing an image (31) on an Internet page (30) associated with a manufacturer (29), a sales organization or a marketing organization for an image-providing appliance (23), having the following method steps:
a) creating the image (31) with the image-providing appliance (23), the image-providing appliance (23) already being in the possession of a customer of the manufacturer (29), the sales organization or the marketing organization for the image-providing appliance (23),
b) automatically assessing the image (31) by using at least one criterion stored on a computer (24) belonging to the image-providing appliance (23),
c) on the basis of the automatic assessment of the image (31), transmitting the image data associated with the image (31) to a computer (23) belonging to the manufacturer (29), the sales organization or the marketing organization for the image-providing appliance (23), and
d) publishing the image (31) on the Internet page (30).

2. The method for publishing an image as claimed in claim 1, in which a criterion for the assessment of the image (31) is the signal-to-noise ratio of the image (31).

3. The method of publishing an image as claimed in claim 1 or 2, in which the appliance is a medical appliance (23).

4. The method of publishing an image as claimed in claim 3, in which a criterion for the assessment of the image (31) is an illness and/or an injury of a person (21) examined with the medical appliance (23).

5. The method of publishing an image as claimed in one of claims 1 to 4, in which the manufacturer (29), the sales organization or the marketing organization defines the criterion or the criteria for the assessment of the image (31).

6. The method of publishing an image as claimed in one of claims 1 to 5, in which the criterion or the criteria for assessing the image (31) can be updated via the Internet.

7. The method of publishing an image as claimed in one of claims 1 to 6, in which the manufacturer (29), the sales organization or the marketing organization defines a ranking of published images (31) and publishes it on a further Internet page (70).

8. The method of publishing an image as claimed in one of claims 1 to 7, in which persons (40) viewing the image (31) can assess the image (31) individually.

9. The method of publishing an image as claimed in claim 8, in which the ranking of the images (31) is carried out by means of an individual assessment by the persons (40).

10. The method of publishing an image as claimed in one of claims 7 to 9, in which there are various rankings for images (31) of various diseases, injuries or patient groups.

11. The method of publishing an image as claimed in one of claims 3 to 10, in which the medical appliance is a computer tomograph, a lithotripter, a magnetic resonance appliance (23) or an X-ray appliance.
